(19) United States
(12) Patent Application Publication
(10) Pub. No.: US 2016/0001198 A1
(43) Pub. Date: Jan. 7, 2016

(54) Mobile Phase Degassing for Nano-Flow Liquid Chromatography

(71) Applicant: The Translational Genomics Research Institute, Phoenix, AZ (US)

(72) Inventors: Tony Tegeler, Phoenix, AZ (US); Konstantinos Petritis, Phoenix, AZ (US)

(73) Assignee: The Translational Genomics Research Institute, Phoenix, AZ (US)

(21) Appl. No.: 14/766,976

(22) PCT Filed: Feb. 25, 2014
(86) PCT No.: PCT/US14/18395

§ 371 Date: Aug. 10, 2015

Related U.S. Application Data
(60) Provisional application No. 61/769,679, filed on Feb. 26, 2013.

(51) Int. Cl. B01D 15/16; G01N 30/34; G01N 30/60; B01D 19/00

(52) U.S. Cl. CPC B01D 15/166; B01D 19/00; G01N 30/34; G01N 30/6095; G01N 2030/027

(57) ABSTRACT

Systems and methods for degassing liquids in nano-flow liquid applications (FIG. 3). In a chromatography embodiment, a system includes a buffer container, a degasser, a buffer pump, a nano-flow pump, and a separation column. The buffer pump is configured to move a buffer from the buffer container through the degasser and the nano-flow pump is configured to move the buffer from the buffer container or the degasser to the separation column.

### CROSS-REFERENCE TO RELATED APPLICATIONS

This application claims the benefit of U.S. Provisional Application 61/769,679, filed Feb. 26, 2013, which is incorporated herein by reference for all purposes.

### FIELD OF INVENTION

The present invention is directed to systems and methods for degassing buffers and solvents for use in nano-flow systems.

### BACKGROUND OF THE INVENTION

Generally, liquid chromatography (“LC”) is a technique for separating components of a mixture, often in which a liquid mobile phase including the mixture filters through a solid stationary phase. Some components of the mixture migrate faster than others through the solid stationary phase (e.g., a separation column), thus causing the components to separate from each other. A detector is used to generate a signal proportional to the amount of each component emerging from the solid stationary phase over time, allowing a quantitative analysis of components within the mixture.

Buffers are often added to the mixture in the mobile phase to help resist local changes in pH. In nano-flow LC, dissolved gas in the buffers results in the formation of gas bubbles in the separation column and can negatively affect various detection methods combined with LC, such as ultraviolet detection, fluorescence detection, and electrospray ionization mass spectrometry. For example, in electrospray ionization mass spectrometry, gas bubbles cause an interrupted and unstable electrospray and, thus, can limit the quality of detection and quantitative analysis.

In nano-flow LC, buffers are typically not degassed. However, some methods exist for limiting the gas dissolved in buffers, including purging buffers with helium while stored in a nano-flow system, sonicating buffers before the buffers are put on the nano-flow system, and subjecting buffers to a vacuum before they are put on the nano-flow system. The drawback of each of these methods is that gas can be redissolved in the buffers by the time they reach the nano-flow separation pump of the system. Redissolved gas still causes gas bubbles in the separation column, resulting in the above-described limitations in detection quality.

Therefore, it would be desirable to provide a system and method for providing degassed buffers to nano-flow pumps in nano-flow liquid chromatography systems to improve detection and quantitation of mobile phase components.

### SUMMARY OF THE INVENTION

Embodiments of the present invention overcome the aforementioned drawbacks by providing systems and methods for degassing buffers in nano-flow liquid chromatography systems. In one example, a system includes a buffer container, a degasser, a buffer pump, a nano-flow pump, and a separation column. The buffer pump is configured to move buffer from the buffer container through the degasser and the nano-flow pump is configured to move the buffer to the separation column.

The foregoing and other aspects and advantages of the invention will be apparent from the following description. In the description, reference is made to the accompanying drawings which form a part hereof, and in which there is shown by way of illustration embodiments of the invention. Such embodiments do not necessarily represent the full scope of the invention, however, and reference is made therefore to the claims and herein for interpreting the scope of the invention.

### BRIEF DESCRIPTION OF THE FIGURES

FIG. 1 is an example chromatogram of E. coli digest run without buffer degassing.

FIG. 2 is an example chromatogram of E. coli digest run with buffer degassing in accordance with embodiments of the invention.

FIG. 3 is a nano-flow liquid chromatography system according to one embodiment of the invention.

FIG. 4 is a nano-flow liquid chromatography system according to another embodiment of the invention.

FIG. 5 is a nano-flow liquid chromatography system according to yet another embodiment of the invention.

### DETAILED DESCRIPTION OF THE INVENTION

Generally, embodiments of the invention provide systems and methods for the degassing of liquid chromatography buffers for use with nano-flow liquid chromatography. These systems and methods enable nano-flow liquid chromatography, combined with detection methods such as ultraviolet detection, fluorescence detection, or electrospray ionization mass spectrometry (“ESI-MS”), to be performed without the formation of gas bubbles in the separation buffers.

With specific reference to ESI-MS, electrospray ionization occurs when ions present in a solution are transferred to the gas phase, as summarized by the following steps. The first step includes the formation of charged droplets at a capillary tip. This process is accomplished by applying a high voltage, such as about 2 to about 3 kilovolts, to a capillary emitter and applying a ground connection to a counter electrode (for example, at the mass spectrometer). Once the charged droplets are formed, evaporation starts to occur, resulting in the charge droplets shrinking and splitting into smaller and smaller droplets. The final result is gas-phase ions dispersed in an electrospray. The total time for this process to happen is on the order of about 100 to about 500 microseconds. The electrospray is observed by mass spectrometer for identification and quantitation of molecules of interest.

The formation of a stable electrospray is important for the accurate identification and quantitation of the molecules of interest. More specifically, if the formation of gas bubbles occur, for example, due to a buffer that was not degassed, the electrospray will be interrupted and the flow of ions into the mass spectrometer will stop. FIG. 1 illustrates an example chromatogram when using a buffer that was not degassed. As shown in FIG. 1, there are a multitude of interruptions to the ion flow due to gas bubbles. In some cases, due to the bubble formation, the electrospray can fail completely and not be able to recover, thus preventing the acquisition of any information during that time.

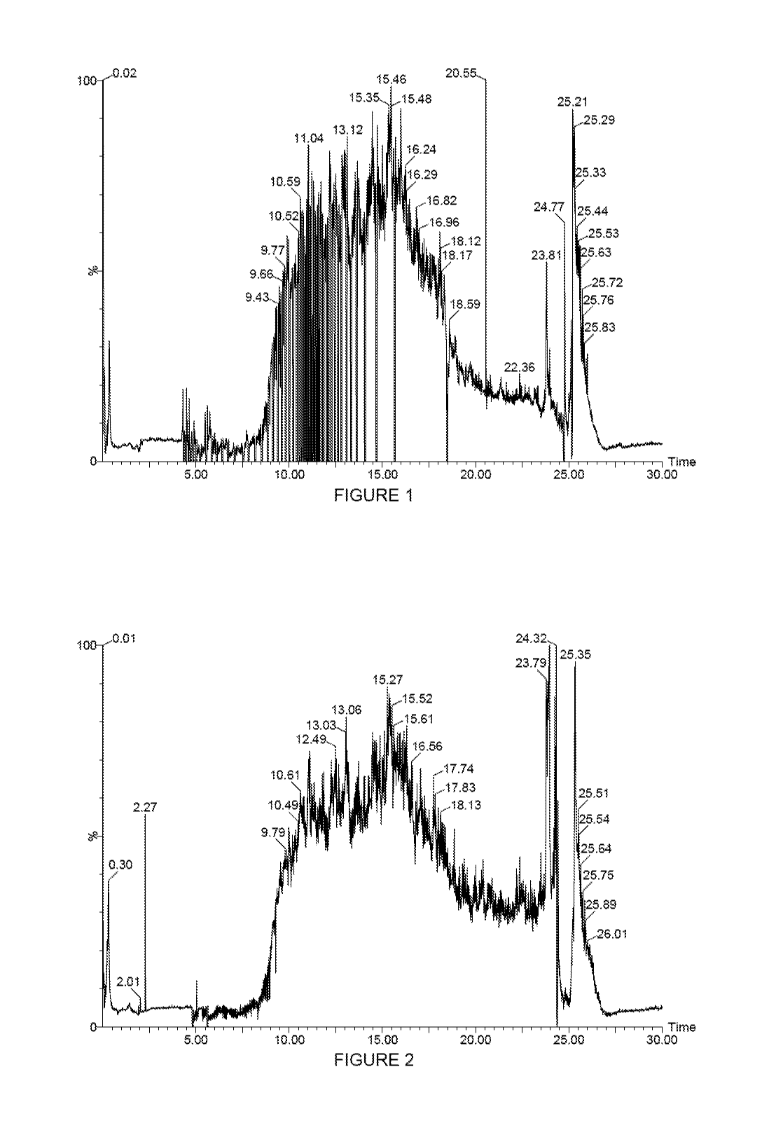

In contrast, FIG. 2 illustrates an example chromatogram when using a degassed buffer, for example, using a system in accordance with embodiments of the present invention, as discussed below, resulting in an uninterrupted ion flow and stable electrospray. A stable electrospray can improve the overall quality of the data since it allows better coefficients of variance, especially for the low abundant analytes, which indirectly improves the limits of detection and quantitation.

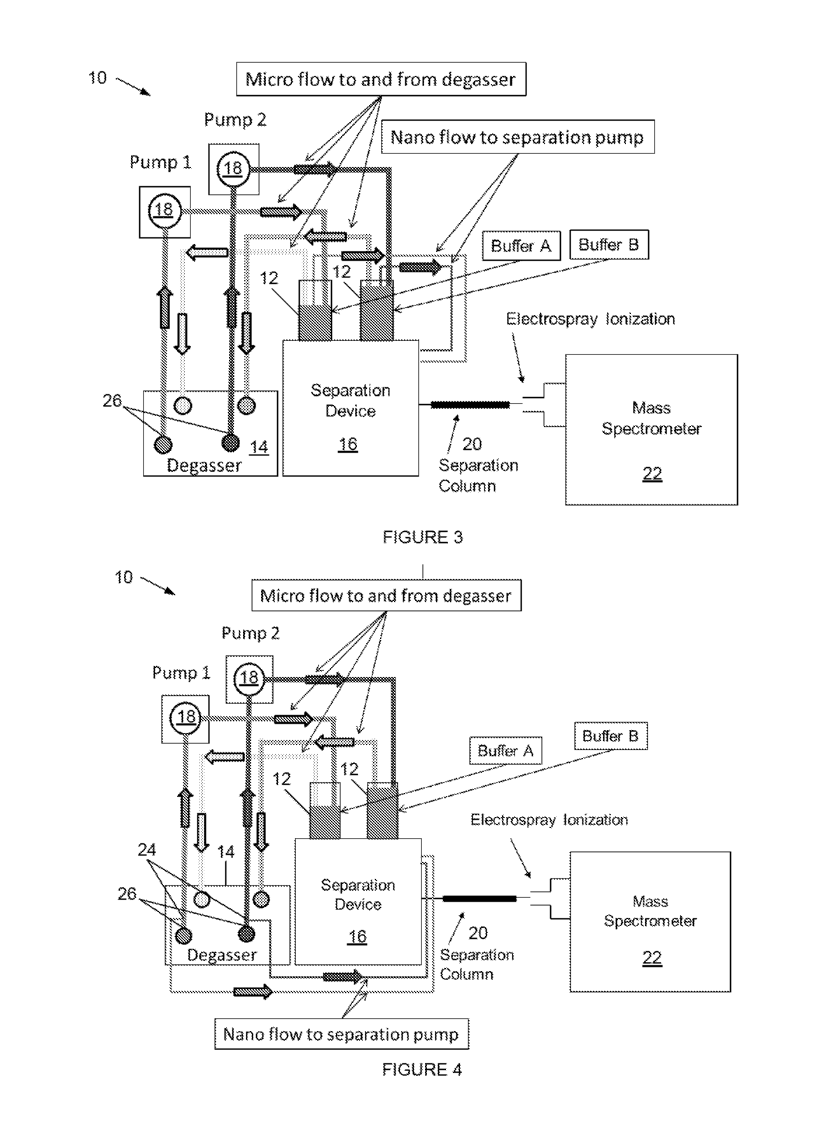

FIGS. 3-5 illustrate example nano-flow systems 10 according to embodiments of the invention. The systems 10 each include one or more buffer containers or bottles 12, a degasser 14, a nano-flow pump 16, buffer pumps 18 (such as micro-flow pumps), a separation column 20, and a mass spectrometer 22. Generally, in some embodiments, buffers are fed from the buffer bottles 12 to the degasser 14 for degassing, then through the nano-flow pump 16 and to the separation column 20 (for example, either directly from the degasser 14 or from the buffer bottles 12). In the systems 10 of FIGS. 3-5, liquid eluting from the separation column 20 is then fed directly to an electrospray and analyzed by the mass spectrometer 22.

More specifically, in the system 10 of FIG. 3, the buffer is pushed or pulled through the degasser 14 by the buffer pumps 18 and returned to the buffer bottles 12. The degassed buffers are then pumped through the nano-flow pump 16 from the buffer bottles 12. The system 10 of FIG. 3 can provide constant or periodic degassing of the buffers to prevent gasses from redissolving in the buffers.

In the system 10 of FIG. 4, the undegassed buffers are pushed or pulled through the degasser 14 by the buffer pumps 18. After buffer degassing, a portion of the degassed buffers is directed toward the nano-flow pump 16, for example via operation of the nano-flow pump 16, resulting in gas-free buffers for nano-liquid chromatography. Another portion of the degassed buffers is directed back toward the buffer bottles 12, for example via the buffer pumps 18. A tee fitting or valve 24 can be provided at outlet connections 26 of the degasser 14 to provide portions of degassed buffer to both the nano-flow pump 16 and the buffer bottles 12. The chromatogram of FIG. 2 was created using the system 10 of FIG. 4.

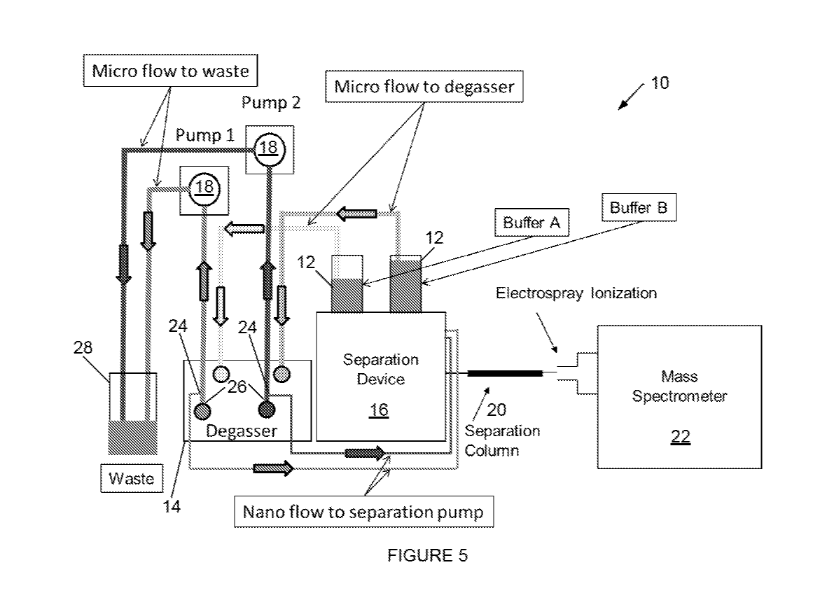

In the system 10 of FIG. 5, the undegassed buffers are pushed or pulled through the degasser 14 by the buffer pumps 18. After buffer degassing, a portion of the degassed buffers is directed through the nano-flow pump 16, resulting in gas-free buffers for nano-liquid chromatography. Another portion of the degassed buffers is directed back toward a waste container 28, for example via the buffer pumps 18. A tee fitting or valve 24 can be provided at outlet connections 26 of the degasser 14 to provide portions of degassed buffer to both the nano-flow pump 16 and the waste container 28.

While embodiments of the present invention have been described with respect to nano-flow liquid chromatography in conjunction with electrospray ionization mass spectrometry, the systems and methods for degassing buffers can be applied to any nano-flow liquid chromatography system. This can include nano-flow liquid chromatography and ultraviolet detection systems, nano-flow liquid chromatography and fluorescence detection systems, or any other nano-flow systems that require degassing buffers or solvents. In addition, as described above, embodiments of the invention utilize mobile phase degassing upstream from nano-flow pumps and, as a result, degassing takes place in capillary or analytical flow and not nano-flow.

The present invention has been described in terms of illustrative embodiments, and it should be appreciated that many equivalents, alternatives, variations, and modifications, aside from those expressly stated, are possible and within the scope of the invention.

1. A nano-flow liquid chromatography system, comprising:
a buffer container,
a degasser in fluid communication with the buffer container,
a buffer pump configured to move a buffer from the buffer container through the degasser,
a nano-flow pump in fluid communication with at least one of the buffer container and the degasser; and
a separation column in fluid communication with the nano-flow pump, wherein the nano-flow pump is configured to move the buffer from one of the buffer container and the degasser to the separation column.

2. The nano-flow liquid chromatography system of claim 1, wherein the buffer pump is configured to move the buffer from the buffer container, through the degasser, and back into the buffer container.

3. The nano-flow liquid chromatography system of claim 1 and further comprising a tee connection positioned at an outlet of the degasser, wherein the tee connection is configured to direct a first portion of the buffer from the degasser toward the buffer container and a second portion of the buffer from the degasser toward the nano-flow pump.

4. The nano-flow liquid chromatography system of claim 1 and further comprising a tee connection positioned at an outlet of the degasser, and a waste container in fluid communication with the degasser, wherein the tee connection is configured to direct a first portion of the buffer from the degasser toward the waste container and a second portion of the buffer from the degasser toward the nano-flow pump.

5. A nano-flow liquid degassing system, comprising:
a buffer container,
a degasser in fluid communication with the buffer container,
a buffer pump configured to move a buffer from the buffer container through the degasser and back to said buffer container, thereby forming a flow of periodically or continuously degassed buffer in both of said buffer container and degasser; and
a nano-flow pump in fluid communication with at least one of the buffer container and the degasser.

6. The nano-flow liquid degassing system of claim 5 and further comprising a tee connection positioned at an outlet of the degasser, wherein the tee connection is configured to direct a first portion of the buffer from the degasser toward the buffer container and a second portion of the buffer from the degasser toward the nano-flow pump.

7. The nano-flow liquid degassing system of claim 5 and further comprising a tee connection positioned at an outlet of the degasser and a waste container in fluid communication with the degasser, wherein the tee connection is configured to direct a first portion of the buffer from the degasser toward the waste container and a second portion of the buffer from the degasser toward the nano-flow pump.

8. A method for nano-flow liquid degassing, comprising:
pumping a liquid from a container through a degasser in fluid communication with the container, thereby forming a degassed liquid; and
pumping said degassed liquid with a nano-flow pump in fluid communication with the degasser.

9. The method of claim 8, further including pumping said liquid from the container through the degasser and back to said container, thereby forming a flow of periodically or continuously degassed liquid in of said container and degasser.

10. The method of claim 9, wherein the nano-flow pump is in fluid communication with at least one of the container and the degasser.
